(19) United States
(12) Patent Application Publication
(10) Pub. No.: US 2026/0185864 A1
(43) Pub. Date: Jul. 2, 2026

(54) PROVIDING VEHICLE ROAD WATER DEPTH ALERTS

(71) Applicant: Volvo Car Corporation, Göteborg (SE)

(72) Inventors: Giovanni Spiritoso, Göteborg (SE); Boyd Stowe, Ridgeville, SC (US); Jessica Areizaga, Ridgeville, SC (US); Charles Leonardi, Ridgeville, SC (US)

(21) Appl. No.: 19/006,359

(22) Filed: Dec. 31, 2024

(51) Int. Cl. G01F 23/80; B60Q 9/00; G06V 10/764; G06V 10/80; G06V 10/94; G06V 20/58

(52) U.S. Cl. CPC G01F 23/802; B60Q 9/00; G06V 10/95; G06V 20/58; G06V 10/764; G06V 10/809

(57) ABSTRACT

A system for providing vehicle road water depth alerts. The system captures data on an external environment using at least one perception sensor of the plurality of perception sensors, wherein the data on the external environment comprises data on a ground surface on a path of the vehicle. The system further detects a hazardous condition associated with the path of the vehicle based on the data that is captured. The system further identifies a type of hazardous condition. The system further determines one or more attributes of the vehicle based on the type of hazardous condition. The system further transmits one or more passage alerts to one or more target recipients based on the hazardous condition and the one or more attributes of the vehicle.

### INTRODUCTION

The present disclosure relates generally to the automotive field. When a vehicle is traveling, a driver may not be able to see hazardous obstacles in the road such as water due to lighting conditions or otherwise poor visibility. Even of the driver sees water on the road, the driver does not have information about nature of the water or any dangerous conditions with regard to the water.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for providing vehicle road water depth alerts. In one illustrative embodiment, the present disclosure provides a system including a plurality of perception sensors, one or more processors, and logic encoded in one or more non-transitory computer-readable storage media for execution by the one or more processors. The logic when executed is operable to cause the one or more processors to perform operations including: capturing data on an external environment using at least one perception sensor of the plurality of perception sensors, where the data on the external environment includes data on a ground surface on a path of the vehicle; detecting a hazardous condition associated with the path of the vehicle based on the data that is captured; identifying a type of hazardous condition; determining one or more attributes of the vehicle based on the type of hazardous condition; and transmitting one or more passage alerts to one or more target recipients based on the hazardous condition and the one or more attributes of the vehicle. Optionally, in some embodiments, the at least one perception sensor of the plurality of perception sensors includes at least one of a camera, a radar detector, a light detection and ranging (Lidar) camera, or an ultrasonic camera. In some embodiments, the hazardous condition is associated with water, where the logic when executed is further operable to cause the one or more processors to perform operations including: detecting water on the path of the vehicle based on the data that is captured; estimating a depth of the water; and transmitting one or more passage alerts to one or more target recipients based on an estimated depth of the water. In some embodiments, the logic when executed is further operable to cause the one or more processors to perform operations including fetching crowdsourced data on the hazardous condition. In some embodiments, the logic when executed is further operable to cause the one or more processors to perform operations including modifying the one or more passage alerts for each target recipient of the one or more target recipients based on one or more alert policies. In some embodiments, at least one passage alert of the one or more passage alerts is transmitted to a driver of the vehicle, and where the at least one service alert indicates if passage through the hazardous condition is safe. In some embodiments, at least one service alert of the one or more service alerts is transmitted to at least one third party entity, and where the least one third party entity alerts other drivers of any hazardous conditions.

In another illustrative embodiment, the present disclosure provides a non-transitory computer-readable storage medium with program instructions stored thereon. The program instructions when executed by one or more processors are operable to cause the one or more processors to perform operations including: capturing data on an external environment using at least one perception sensor of the plurality of perception sensors, where the data on the external environment includes data on a ground surface on a path of the vehicle; detecting a hazardous condition associated with the path of the vehicle based on the data that is captured; identifying a type of hazardous condition; determining one or more attributes of the vehicle based on the type of hazardous condition; and transmitting one or more passage alerts to one or more target recipients based on the hazardous condition and the one or more attributes of the vehicle. Optionally, in some embodiments, the at least one perception sensor of the plurality of perception sensors includes at least one of a camera, a radar detector, a light detection and ranging (Lidar) camera, or an ultrasonic camera. In some embodiments, the hazardous condition is associated with water, where the instructions when executed are further operable to cause the one or more processors to perform operations including: detecting water on the path of the vehicle based on the data that is captured; estimating a depth of the water; and transmitting one or more passage alerts to one or more target recipients based on an estimated depth of the water. In some embodiments, the instructions when executed are further operable to cause the one or more processors to perform operations including fetching crowdsourced data on the hazardous condition. In some embodiments, the instructions when executed are further operable to cause the one or more processors to perform operations including modifying the one or more passage alerts for each target recipient of the one or more target recipients based on one or more alert policies. In some embodiments, at least one passage alert of the one or more passage alerts is transmitted to a driver of the vehicle, and where the at least one service alert indicates if passage through the hazardous condition is safe. In some embodiments, at least one service alert of the one or more service alerts is transmitted to at least one third party entity, and where the least one third party entity alerts other drivers of any hazardous conditions.

In a further illustrative embodiment, the present disclosure provides a computer-implemented method for providing vehicle road water depth alerts, the method including: capturing data on an external environment using at least one perception sensor of the plurality of perception sensors, where the data on the external environment includes data on a ground surface on a path of the vehicle; detecting a hazardous condition associated with the path of the vehicle based on the data that is captured; identifying a type of hazardous condition; determining one or more attributes of the vehicle based on the type of hazardous condition; and transmitting one or more passage alerts to one or more target recipients based on the hazardous condition and the one or more attributes of the vehicle. Optionally, in some embodiments, the at least one perception sensor of the plurality of perception sensors includes at least one of a camera, a radar detector, a light detection and ranging (Lidar) camera, or an ultrasonic camera. In some embodiments, the hazardous condition is associated with water, and where the method further includes: detecting water on the path of the vehicle based on the data that is captured; estimating a depth of the water; and transmitting one or more passage alerts to one or more target recipients based on an estimated depth of the water. In some embodiments, the method further includes fetching crowdsourced data on the hazardous condition. In some embodiments, the method further includes modify the one or more passage alerts for each target recipient of the one or more target recipients based on one or more alert policies. In some embodiments, at least one passage alert of the one or more passage alerts is transmitted to a driver of the vehicle, and where the at least one service alert indicates if passage through the hazardous condition is safe.

### BRIEF DESCRIPTION OF THE DRAWINGS

The present disclosure is illustrated and described with reference to the various drawings, in which like reference numbers are used to denote like system components and/or method steps, as appropriate.

FIG. 1 is a block diagram of an example environment for providing vehicle road water depth alerts.

FIG. 2 is a flow chart for providing vehicle road water depth alerts.

FIG. 3 is a top-view block diagram of a vehicle in an environment.

FIG. 4 is a side-view block diagram of a vehicle in an environment.

FIG. 5 is a block diagram of an environment, showing a view toward the front interior of a vehicle.

FIG. 6 is a block diagram of an example high-level architecture for providing vehicle road water depth alerts.

FIG. 7 is a block diagram of an example network environment of the present disclosure.

FIG. 8 is a block diagram of an example computing system of the present disclosure.

### DETAILED DESCRIPTION

A system for providing vehicle road water depth alerts. As described in more detail herein, embodiments provide road condition estimations such as water level heights, etc., and assessments as to whether water on a given road is safe for a vehicle to cross. Embodiments provide alerts to one or more drivers and appropriate recommendations with regard to their respective vehicles safely crossing potentially hazardous bodies of water (e.g., water due to flooding, etc.). Embodiments and provide communication protocols for sharing information among a system, one or more vehicles, and one or more third-party entities in order increase safety in crossing water or preventing crossing of the water.

As described in more detail herein, embodiments use a variety of perception devices such as cameras and other sensors to determine if road water may be safely traversed given observations, vehicle height/weight, equipment, tire condition, etc. Depth, force of current, and speed of water are determined, and any vehicle parameters may be considered, even including identified driver experience/inexperience.

As described in more detail herein, while various embodiments are described in the context of water on a road, these embodiments also apply to any hazard (e.g., road terrain, fallen trees, etc.), a water crossing being one example. The system displays hazards and associated alerts with appropriate warnings and recommendations. Also, the system may employ driver assistance, and may suggest alternate routes. The system utilizes artificial intelligence (AI) methodologies to perform assessments based on data collect by perception devices, as well as data associated with vehicle engine conditions, tire conditions, hazard conditions, successful/unsuccessful passages, etc. Also, communications including alerts, recommendation, etc., are broadcast vehicle-to-vehicle (V2V), vehicle to cloud (V2C), and/or vehicle-to-infrastructure (V2I).

The system captures data on an external environment using at least one perception sensor of the plurality of perception sensors, where the data on the external environment includes data on a ground surface on a path of the vehicle. The system further detects a hazardous condition associated with the path of the vehicle based on the data that is captured. The system further identifies a type of hazardous condition. The system further determines one or more attributes of the vehicle based on the type of hazardous condition. The system further transmits one or more passage alerts to one or more target recipients based on the hazardous condition and the one or more attributes of the vehicle.

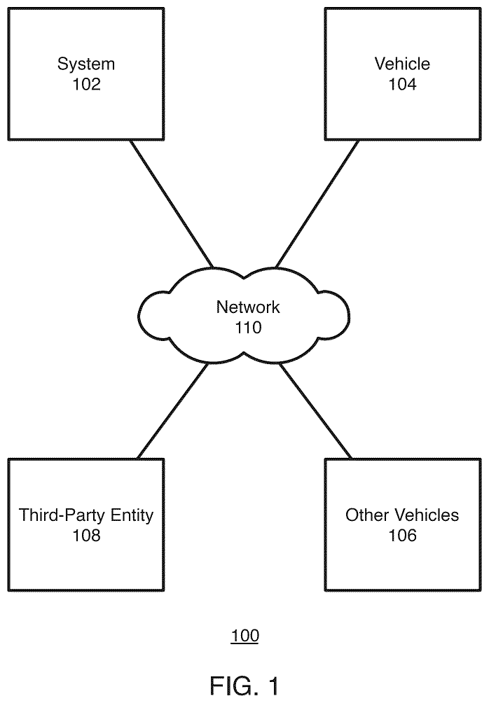

FIG. 1 is a block diagram of an example environment 100 for providing vehicle road water depth alerts. Shown are blocks that represent a system 102, a vehicle 104, other vehicles 106, a third-party entity 108, and a network 110. As described in more detail herein, when the vehicle 104 approaches an object such as water on the road, the system 102 utilizes perception sensors of the vehicle 104 to collect data on the water such as the size of the road surface area covered, the depth of the water, etc. The system 102 analyzes the data and determines if it is safe for the vehicle 104 to cross the water. The system 102 transmits an alert or warning indicator to the driver of the vehicle 104 indicating whether the vehicle 104 can safely cross the water or not. Further example embodiments directed to perception sensors are described in more detail below.

The system 102 may also transmit alerts directly to other vehicles 106 to warn their respective drivers of the water and potential hazard. The system may also transmit an alert a third-party entity 108 of the water and potential hazard. The third-party entity 108 may be a traffic control center, for example. If the water poses a hazardous condition to the vehicle 104, the third-party entity may transmit alerts to other vehicles 106 that approach the water. Further example embodiments directed to alerts to the vehicle 104, other vehicles 106, or the third-party entity 108 or other third-party entities are described in more detail below.

The system 102 may communicate with the vehicle 104, the other vehicles 106, and the third-party entity 108 directly or via a network 110. The network 110 may be any suitable communication network such as a Bluetooth network, a Wi-Fi network, the Internet, etc.

For ease of illustration, FIG. 1 shows one block for each of the system 102, the vehicle 104, the other vehicles 106, the third-party entity 108, and the network 110. Blocks 102, 104, 106, 108, and 110 may represent multiple systems, vehicles, third-party entities, or networks. In other embodiments, environment 100 may not have all of the components shown and/or may have other elements including other types of elements instead of, or in addition to, those shown herein.

While system 102 performs embodiments described herein, in other embodiments, any suitable component or combination of components associated with system 102 or any suitable processor or processors associated with system 102 may facilitate performing the embodiments described herein.

While the system 102 is shown in the example embodiment of FIG. 1 as being separate from the vehicle 104, in various embodiments, the system 102 may also be on board or integrated with the vehicle 104.

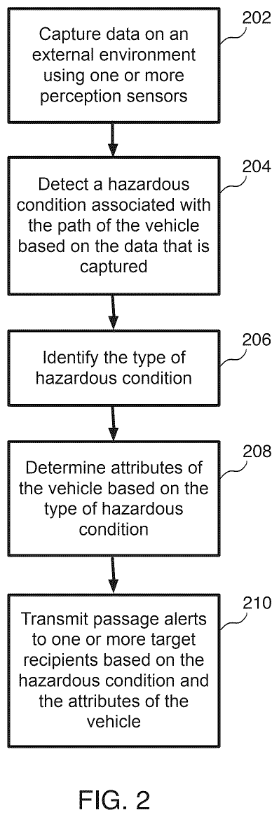

FIG. 2 is a flow chart for providing vehicle road water depth alerts. Referring to both FIGS. 1 and 2, a method is initiated at block 202, where a system such as system 102 captures data on an external environment using one or more perception sensors, where the data on the external environment includes data on a ground surface on a path of the vehicle. As described in more detail herein, the data on the ground surface may include data on aspects of a hazardous object such as water on the path of the vehicle (e.g., water size, water depth, etc.). Example embodiments directed to data on the ground surface, which includes data on aspects of any bodies of water on the road are described in more detail herein.

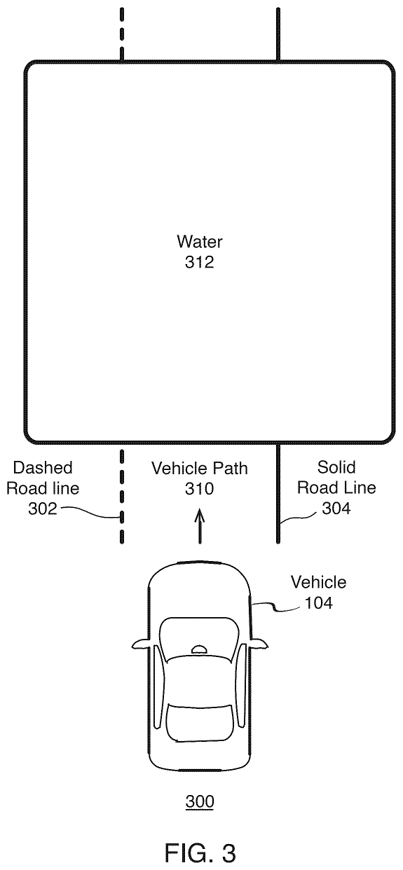

At block 204, the system 102 detects a hazardous condition associated with the path of the vehicle based on the data that is captured. The following FIG. 3 illustrates an example scenario, where the hazardous condition is a body of water.

FIG. 3 is a top-view block diagram of a vehicle in an environment 300. Shown is vehicle 104 (FIG. 1) traveling on a road along a vehicle path 310. Shown is a dashed road line 302 and a solid road line 304 on the vehicle path 310. The dashed road line 302 may indicate either a separator between the lane that the vehicle 104 is traveling and a second lane for other vehicles traveling going the same direction as the vehicle 104, or may indicate a separator between the lane the vehicle 104 is traveling and a lane for vehicles traveling the opposite direction as the vehicle 104 (e.g., oncoming traffic). The solid road line 304 indicates to the driver the side road line in the road that separates the vehicle 104 from the shoulder of the road. In some scenarios, road lines may be non-existent.

In this scenario, there is a hazardous object on the vehicle path, which is a body of water 312. As described in more detail herein, the system 102 determines whether it is safe for the vehicle 104 to cross the water 312.

As indicated herein, in various embodiments, the vehicle 104 utilizes a variety of perception sensors coupled to the vehicle 104, and such perception sensors enable the system 102 and the vehicle 104 to monitor various aspects of the vehicle 102 (e.g., engine aspects including mechanical and electrical systems, tire aspects, etc.), and monitor various aspects of the hazardous object such as a body of water (e.g., water depth, etc.). The particular perception sensors may vary, depending on the particular implementation.

At block 206, the system 102 identifies the type of hazardous condition. For example, in various embodiments, the system may identify an object in the path of the vehicle 104, and that the object creates a hazardous condition. In various embodiments, the hazardous condition may be associated with water. In such scenarios, the system detects water on the path of the vehicle based on the data that is captured. The system may determine that the object is sufficiently large such as large body of water. While embodiments described herein are described in the context of hazardous water, the embodiments may also identify any object or objects in the path of the vehicle that may pose a hazard. For example, as described in more detail herein, the system may detect objects such as snow, rocks, boulders, debris, etc.

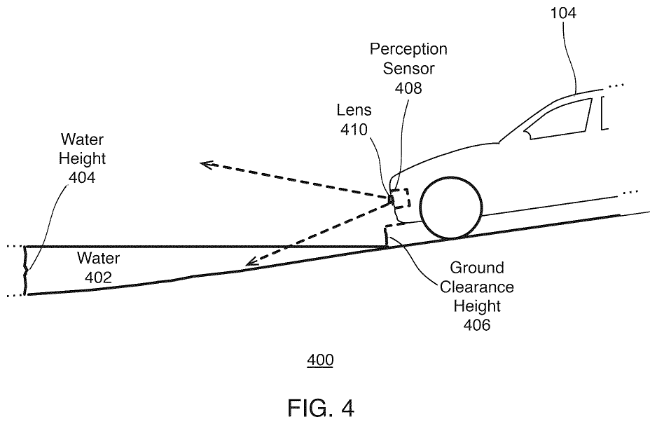

In various embodiments, the system 102 may analyze the data to determine the size of the road surface area covered, the depth of the water, etc. For example, the system may determine if the water is merely thin surface water from rain, or deep water from flooding. FIG. 4 describes a scenario describes a scenario where the object is a body of water and the water is deep thereby causing a hazardous condition.

FIG. 4 is a side-view block diagram of a vehicle in an environment 400. Shown is the vehicle 104 (FIG. 1) traveling on a road having water 402 on the road. In this scenario, the water 402 is deep due to flooding. The water height 404 substantially high and significantly higher than the ground clearance height 406 of the vehicle 104.

As indicated herein, the vehicle 104 has multiple perception sensors that capture and collect data on the environment 400 external to the vehicle 104. For ease of illustration, one perception sensor 408 with a lens 410 is shown. In various embodiments, the perception sensor 406 and/or other perception sensors may be positioned at various exterior portions of the vehicle. Being positioned at the exterior portions of the vehicle 104 means that at least one portion of the perception sensor 408 (e.g., the lens 410) is exposed to the environment 400. There may be any number of perception sensors and any number of types of perception sensors. In some embodiments, one or more of the perception sensors may be positioned at an interior portion of the vehicle. For example, one or more of the perception sensors may be positioned inside with view through a window (e.g., behind the front windshield, near the rear-view mirror, etc. As such, the perception sensor 408 and/or or other perception sensors capture various types of data on the environment 400.

In various embodiments, the system 102 may utilize multiple perception sensors and multiple types of perception sensors and sensors to capture data on the external environment 400. For example, in various embodiments, the perception sensors may include any one or more of a camera, a radar detector, a Lidar camera, and an ultrasonic camera, and/or other types of sensors and cameras to collect data. Any sensing methodology may be used, and the particular sensing methodology will depend on the particular implementation. For example, in various embodiments, one or more of the perception sensors may include one or more image sensing perception sensors or cameras, radar detectors, and/or ultrasonic cameras, or any combination thereof. One or more perception sensors may also include infrared (IR) perception sensors or cameras. In various embodiments, the system may utilize any one or more of these perception sensors and/or other types of sensors and cameras to collect data. Such data collected may include data on objects on the road. While embodiments are described herein in the context of water such as the water 402, the perception sensors may collect data on a variety of objects such as bumps, trash, dead animals, rocks, etc. The data may include Lidar data and well as images. The images may be a continuous series of images, which may include video. For ease of illustration, the perception sensor is 408 is shown positioned on the bumper of the vehicle 104. In various embodiments, the perception sensor 408 and/or other sensors and cameras may also be positioned or mounted underneath the vehicle 104.

The perception sensor 408 may be referred to as a client device, which may communicate with the system 102. Such communication may be facilitated via any suitable communication network (not shown) such as a wired network, a Bluetooth network, a Wi-Fi network, etc., or any combination thereof.

In various embodiments, the data on the environment 400 includes data on a ground surface on a path of the vehicle. The system 102 detects objects in the vehicle path based on the data that is captured. The system 102 estimates various aspects of the objects on the road by analyzing data collected on the objects, as described herein. For example, the system 102 may estimate the size or surface area of any bodies of water such as the water 402 on the road.

If the water is deep, the system 102 analyzes the data collected by various perception sensors to determine or estimate the depth of the water 402. The system may also determine different depths of the water 402 at different points on the road. The system 102 may also identify movement of the water. In various embodiments, the system may determine from the combination movement of the water and the size of the water surface if the water is dangerous. For example, if the body of water is large, more movement in one direction such as current movement may indicate deep water. Also, if the body of water is large (e.g., larger that the size of the car, etc.) and the movement is fast, this may indicate that the vehicle could potentially be swept away by the current of the water.

At block 208, the system 102 determines one or more attributes of the vehicle based on the type of hazardous condition. For example, in various embodiments, the system 102 may determine the make and model of the vehicle 104 by querying the information from a database accessible by the system 102 and/or by querying the information from data stored at the vehicle 104. The system may also determine from the make and model, the specifications of the vehicle. For example, the vehicle specification may include the ground clearance of the vehicle 104, the weight of the vehicle 104, etc. The system may query the vehicle 104 whether the vehicle 104 has any special systems and/or parts such as hydraulic or pneumatics system that can increase the ground clearance, etc.

In various embodiments, the system 102 assesses the severity level of the water 402, level of safety for the vehicle to cross the water. To assess the severity level of water and the safety level for crossing the water 402, the system compares the attributes of the vehicle against the type of hazardous condition. For example, if the water is 1 and half feet deep and the vehicle 104 is an SUV, the system may determine that it is safe for the vehicle 104 to cross the water. If the vehicle 104 is a sedan, the system may determine that it is not safe for the vehicle 104 to cross the water. If the water is 3 feet deep, the system may determine that it is not safe for any vehicle 104 to cross the water.

As indicated herein, while various embodiments are described herein in the context of water, the object that the system 102 detects on the road surface, and for which the system 102 computes the severity level and the level of safety for passing may be applied to different objects. For example, the system may detect objects such as snow, rocks, boulders, debris, etc.

In various embodiments, the system fetches crowdsourced data associated with the hazardous condition. In some scenarios, the vehicle 104 might not be the first vehicle to encounter the hazardous condition. Also, another vehicle may have encountered the hazardous condition and reported the hazardous condition to the system and/or to a third-party entity that collects information on the hazardous conditions. For example, the system may determine from fetched crowdsourced data characteristics of the water such as the water height, movement of the water, whether other vehicles are successfully crossing the water, the types of vehicles that successfully cross the water, the types of vehicles that are not able to successfully cross the water, etc. Such information may be used to send alerts and recommendations for future vehicles that approach the hazardous object or body of water.

At block 210, the system 102 transmits one or more passage alerts to one or more target recipients based on the hazardous condition and the one or more attributes of the vehicle. The term passage alert may be used interchangeably with the terms alert, hazard alert, warning, etc. Also, a given passage alert may indicate that a body of water is safe to cross, not safe cross, a recommendation with regard to crossing, any information about the nature of the water, etc. In various embodiments, the system tailors or modifies the passage alerts for each target recipient based on one or more alert policies. For example, in various embodiments, one policy may be for the system transmit a passage alert to the driver of the vehicle, where the passage alert indicates if passage through the hazardous condition is safe. One policy may be for the system to inform the driver of the vehicle 104 about safe passage through water based on the vehicle specifications and/or features unique to the vehicle 104. One policy may be for the system to broadcast to the vehicle 104, to other vehicles 106, and to any third-party entity 108 of the nature of the water hazard such as the size of the body of water, the depth of the water, and any other characteristics such as current force, current speed, etc. If a given vehicle is able to successfully and safely cross the water, a policy may be to collect information about the vehicle that made it possible to cross safely (e.g., the vehicle being an SUV, etc.), and then to broadcast such information to the vehicle 104, the other vehicles 106, and to any third-party entity 108. Various embodiments directed to different alerts and different information for different types of recipients are described in more detail herein.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time. Also, some embodiments may not have all of the steps shown and/or may have other steps instead of, or in addition to, those shown herein.

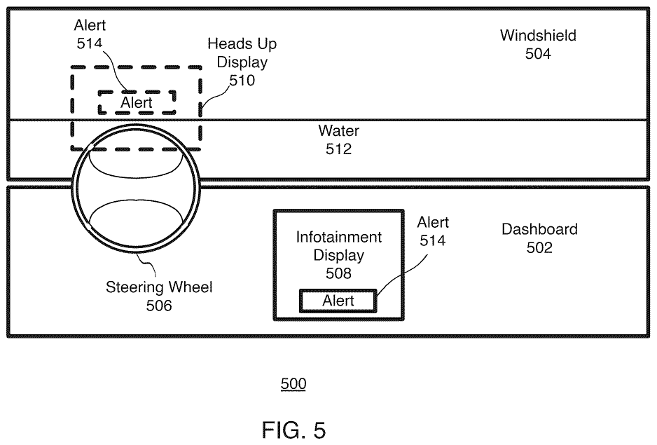

FIG. 5 is a block diagram of an environment 500, showing a view toward the front interior of a vehicle. This portion of the vehicle may be that of the vehicle 104 shown in FIGS. 1, 3, and 4. Shown is a dashboard 502, a windshield 504, a steering wheel 506, an infotainment display 508, a heads up display 510, and a body of water 512. In this example scenario, the water 512 is visible through the windshield 504. There may also be scenarios where the driver might not see the water 512 due to distractions. For example, such distractions may include the driver looking at the driver's mobile device instead of the vehicle path. Another example distraction may be the driver looking at another person in the vehicle during a conversation, etc.

In various embodiments, when the system 102 determines that the water 512 is not mere surface water but instead deep water that is hazardous, the system causes the alert 514 to be displayed on the infotainment display 508 and/or the heads up display 510. In some embodiments, the system may also display the water 510 or a visible representation of the water 512 on the infotainment display 508 and/or the heads up display 510 in order to provide or increase visual awareness to the driver of the water 512. The system 102 may similarly display if appropriate an alert and a visible representation of any other hazardous objects on the road on the infotainment display 508 and/or the heads up display 510 in order to provide or increase visual awareness to the driver of the hazardous objects, which increase awareness of the external environment for safer driving.

In various embodiments, the heads up display 510 provides an augmented reality (AR) windshield showing the actual physical road and augments or overlays the road seen through the windshield 504 with any hazardous objects such as the water 512, or other hazardous objects. Further example embodiments directed to AR information that the system may display one the infotainment display 508 and the heads up display 510 are described in more detail herein.

In various embodiments, in the infotainment display 508 and/or the heads up display 510, the system may provide enhanced visual footage or representations of the water 512 or other physical objects. For example, the system may capture the water 512 in the form of one or more images or video using one or more perception sensors. The system may process the images to enhance or clarify the images for better visibility and awareness of the external environment. For example, the object 112 may be obscured due to weather elements such as fog, rain, snow, etc. The system may apply digital photography filters to display images of the water 512. As a result, an actual physical view of the water 512 that might be very visible becomes more visibly or prominent that the driver could better see and be better aware of the water 512, or any other hazardous objects. For example, there may be fallen trees or tree limbs, debris, etc., in addition to flooding.

In various embodiments, the system may display different types of images of a given object such as the water 512. For example, different types of images may include enhanced or filtered images of a physical object, created representations of the physical object, representations of the physical object fetched from the cloud, etc. For clarity and ease of illustration, these different types of images are referred to as virtual to distinguish them from the actual physical object that may be less visible. Accordingly, the system displays as a part of the alert 514 on the infotainment display 508 and/or the heads up display 510.

In various embodiments, in the infotainment display 508 and/or the heads up display 510, the system may provide augmented information in addition to actual or substitute representations of the water 512. For example, the system may augment the information with water depth information, water current information, etc.

Such information may be in the form of numbers. For example, the system may display maximum water depths (e.g., 1 foot, 1.7 feet, 2.5 feet, 3 feet, etc.). The system may display water movement speed (e.g., 0.5 knots, 1 knots, 2 knots, etc.). The system may display graphical information. For example, the system may display a horizontal line representing the surface of the water 512, a vertical line representing the maximum depth of the water, etc. In various embodiments, the system may show multiple different water depths at different respective points or locations of the water 512.

In various embodiments, the passage alerts may provide additional indications to increase awareness of hazards for the driver. While the word “Alert” is shown both in the example infotainment display 508 and the heads up display 510, the actual word or words may vary, and will depend on the particular implementation. For example, the system may display any words of warning in a passage alert, such as “Warning,” “Deep Water,” “Falling Tree,” “Do not proceed forward,” “Safe to proceed with caution, etc. Also, the system may make the alert in a predetermined color (e.g., red, etc.) to enhance the alert. As such, the driver may slow down and turn to avoid driving through the water 512.

In various embodiments, the system 102 may verbally navigate (e.g., via speakers) or visually navigate (e.g., via visual images on the infotainment display 508 and/or the heads up display 510) the driver to drive through the water 512 along a safe path. The safe path would be along the shallowest points in the water 512. In some embodiments, the safe path may be a street or road route to drive instead of the current road.

In various embodiments, in the case of autonomous vehicles or similar autonomous capabilities, the system 102 may implement automatic safety actions, such as automatically breaking to slow down or halt the vehicle. The system may also take control of the steering of the vehicle to automatically pull over or drive through any safe or sufficiently shallow portions of the water 512.

As indicated above, the system enables various types of communications using appropriate communication protocols involving vehicle-to-vehicle (V2V), vehicle to cloud (V2C), and/or vehicle-to-infrastructure (V2I).

In various embodiments, the system transmits at least one service alert to at least one third party entity. In this scenario, the third party receives the service alert and in turn alerts other drivers of any hazardous conditions. In various embodiments, the system may assess the hazardous condition based on various aspects (e.g., water depth, etc.), and then determine what types of vehicles can cross the water. Vehicles that are deemed safe to cross may be deemed to be vehicles with heigh passability. In contrast, vehicles that are deemed not safe to cross may be deemed to be vehicles with low passability. In various embodiments, the third-party entity may provide traffic control, where the third-party entity provides instructions to vehicles with high passability to proceed, while providing instructions to vehicles with low passability to not proceed. The system may also provide instructions or recommendation to low passability vehicles follow a reroute or to pull over and allow more suitable vehicles to continue, etc.

Share information about the vehicle 104 if the vehicle 104 is able to cross the water. For example, if the system determines that the vehicle 104 was able to safely pass, the system may communicate to the third-party entity 108 and/or directly to other vehicles 106 the vehicle specifications that made it safe for the vehicle to cross the water. As such, alerts may be sent out or broadcast to the third-party entity 108 and/or directly to other vehicles 106 with relevant information. For example, if it's safe for all SUV's to cross, or if it is not safe for sedans to cross, the alert may be tailors or modified to communicate such information.

In some embodiments, the system 102 may adjust a ground clearance height 406 of the vehicle 104 as needed based on the hazardous condition if the vehicle has such capabilities to modify the ground clearance height 406. For example, the system may estimate the depth of the water, the height of the object, etc. The system then adjusts of the ground clearance height 406 of the vehicle, which may include adjusting a suspension of the vehicle. In some embodiments, the system may adjust of the ground clearance height of the vehicle by adjusting the tire pressure of one or more tires of the vehicle. Such increase to the ground clearance height 406 may enable the vehicle 104 to clear a hazardous object such as the water 402 if the estimated water depth or height 404 is greater than the current ground clearance height 406. In this scenario, the system increases the ground clearance height 406 to be greater than the estimated water depth or height 404.

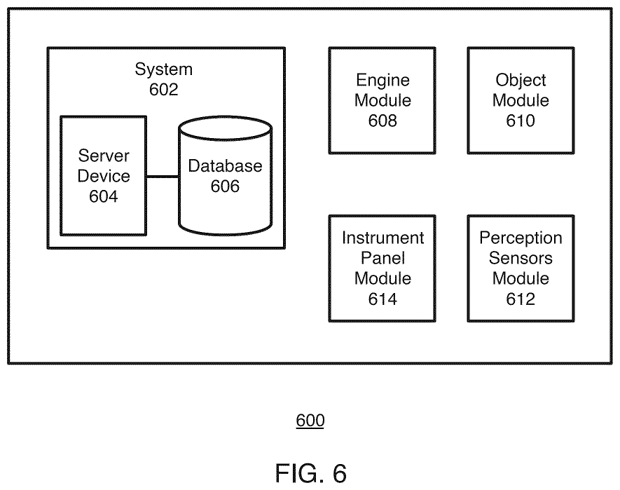

FIG. 6 is a block diagram of an example high-level architecture for providing vehicle road water depth alerts. Shown is a system 602, which may be used to implement the system 102 of FIG. 1. The system 602 includes a server device 604 and a database 606. Also shown is an engine module 608, an object module 610, a perception sensors module 612, and an instrument panel module 614. The engine module 608, the object module 610, the perception sensors module 612, and the instrument panel module 614 may be implemented using a combination of hardware and software. In various embodiments, the software may include and execute any suitable AI model, including any AI, machine learning, and computer vision techniques to track the performance of various components of the vehicle, including the engine and any associated systems, the wheels and any associated systems, etc. The system may utilize the AI model to detect any problems with the vehicle 104 and to perform any needed actions such a sending out one or more alerts, taking any automatic safety actions of the vehicle, etc., and thereby maximize safety associated with the vehicle 104 as described herein.

The system 602 communicates data signals and control signals with the engine module 608, the object module 610, the perception sensors module 612, and the instrument panel module 614 via the server device 604. The database 606 may be used to store various types of information such as capabilities of the vehicle 104 with respect different water depths, associated alert triggers for the capabilities of the vehicle 104 with respect different water depths, predetermined severity levels, predetermined severity levels and thresholds (e.g., water depths that are too deep or high for the particular vehicles, etc.) associated with water depth for the capabilities of the vehicle 104 with respect different water depths, actions associated with particular vehicle capabilities and associated with particular severity thresholds and levels for the capabilities of the vehicle 104, corrective actions associated with the capabilities of the vehicle 104 with respect different water depths, information in alerts to the vehicle 104 and driver, to the other vehicles 106, to the third-party entity 108, etc., as well as AI training information, for example.

The system enables the engine module 608 to monitor and track the performance of systems and components associated with the engine of the vehicle. For example, in scenarios where the water level is relatively deep yet safe for the vehicle to cross, the system may monitor the performance of systems and components to detect if the water has had any adverse effect (e.g., negatively impaired any vehicle operations or parts, etc.) during any water crossing or after any water crossing. The vehicle module 608 may also provide the system 102 with any vehicle information such as vehicle specification information, special equipment information, special capabilities information, weight, equipment, tire condition, etc.

In various embodiments, the engine module 608 may also access information with regard to special capabilities information associated with manufacture-provided parts and/or aftermarket parts. Such information is helpful for the system determine whether the vehicle 104 may safely cross the water.

The system also enables the perception sensors module 612 to control the perception sensors. The system also enables the instrument panel module 614 to control information displayed on the instrument panel and to enable the driver to interact with the infotainment display or system of the instrument panel.

The system enables the object module 610 to monitor and track various aspects of the body of water or other hazardous objects on the vehicle path. For example, the object module 610 may log and store depth data, size data, the speed of the water, etc. collected by the perception sensors. The object module 610 may log and store any changes or patterns or trends associated with the water (e.g., changes in the depth data, size data, etc.) collected by the perception sensors. The system enables the perception module 612 to operate, store, and track all data associated collected by the perception sensors. The system enables the instrument panel module 614 to provide alert information and any associated information describe herein in the infotainment display and/or the heads up display.

Embodiments described herein have numerous benefits. For example, embodiments provide a driver with not only alerts involving hazardous objects in a vehicle path but also alerts when a hazardous object is a body of water. Embodiments also assess the severity level of the water, as well as make recommendations to a driver whether passage through the water is safe, or not safe. Embodiments also help to navigate a vehicle through a body of water in a manner and/or route that is safe for the vehicle and passengers.

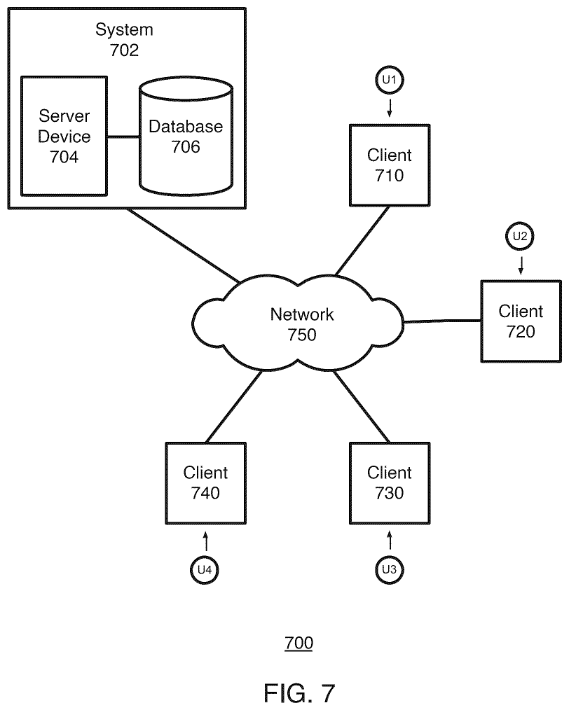

FIG. 7 is a block diagram of an example network environment 700 of the present disclosure. In some embodiments, network environment 700 includes a system 702, which includes a server device 704 and a database 706. In various embodiments, the system 702 may be used to implement the system 102 of FIG. 1, as well as to perform embodiments described herein. The network environment 700 also includes the client devices 710, 720, 730, and 740, which may communicate with the system 702 and/or may communicate with each other directly or via the system 702. The network environment 700 also includes a network 750 through which the system 702 and the client devices 710, 720, 730, and 740 communicate. The network 750 may be any suitable communication network such as a Wi-Fi network, Bluetooth network, wide area network (WAN), local area network (LAN), the Internet, etc.

For ease of illustration, FIG. 7 shows one block for each of the system 702, server device 704, and the network database 706, and shows four blocks for the client devices 710, 720, 730, and 740. The blocks 702, 704, and 706 may represent multiple systems, server devices, and network databases. Also, there may be any number of client devices. In other embodiments, the environment 700 may not have all of the components shown and/or may have other elements including other types of elements instead of, or in addition to, those shown herein.

While the server device 704 of the system 702 performs embodiments described herein, in other embodiments, any suitable component or combination of components associated with the system 702 or any suitable processor or processors associated with the system 702 may facilitate performing the embodiments described herein.

In the various embodiments described herein, a processor of the system 702 and/or a processor of any the client device 710, 720, 730, and 740 cause the elements described herein (e.g., information, etc.) to be displayed in a user interface on one or more display screens.

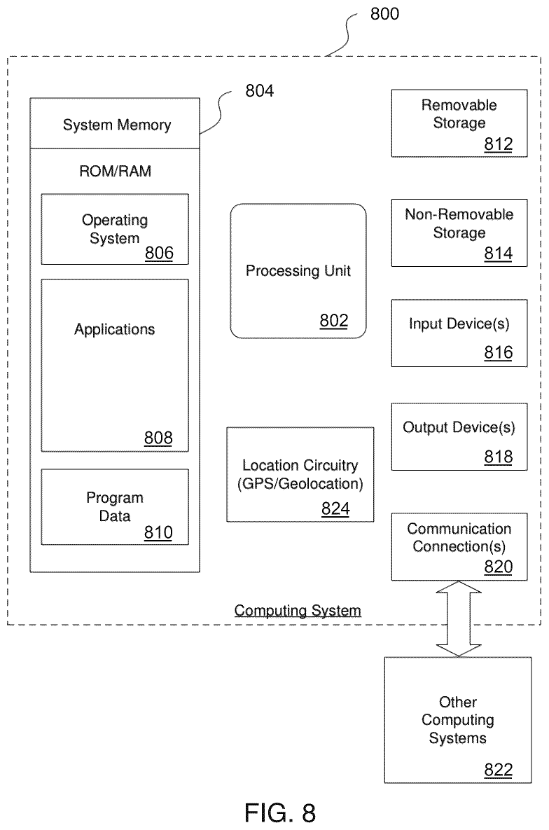

FIG. 8 is a block diagram of an example computing system 800 of the present disclosure. The computing system 800 may be used to implement the system 102 of FIG. 1 and/or the server system 702 of FIG. 7 and/or, as well as to perform embodiments described herein.

The computing system 800 typically includes at least one processing unit 802 and a system memory 804. Depending on the particular configuration and type of computing device, the system memory 804 may be volatile such as random-access memory (RAM), non-volatile such as read-only memory (ROM), flash memory, and the like, or some combination of volatile memory and non-volatile memory. The system memory 804 typically maintains an operating system 806, one or more applications 808, and program data 810. The operating system 806 may include any number of operating systems executable on desktops or portable devices including, but not limited to, Linux, Microsoft Windows®, Apple OS®, or Android®.

The computing system 800 may also have additional features or functionality. For example, the computing system 800 may also include additional data storage devices (removable and/or non-removable) such as, for example, magnetic disks, optical disks, tape, or flash memory. Such additional storage may include a removable storage 812 and a non-removable storage 814. Computer storage media may include volatile and non-volatile, removable and non-removable media implemented in any method or technology for storage of information, such as computer-readable instructions, data structures, program modules or other data. The system memory 804, the removable storage 812, and the non-removable storage 814 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 800. Any such computer storage media may be part of the computing system 800.

The computing system 800 may also have input device(s) 816 such as a keyboard, mouse, pen, voice input device, touchscreen input device, etc. Output device(s) 818 such as a display, speakers, printer, short-range transceivers such as a Bluetooth transceiver, etc., may also be included. The computing system 800 also may include one or more communication connections 820 that allow the computing system 800 to communicate with other computing systems 822, such as over a wired or wireless network or via Bluetooth (a Bluetooth transceiver may be regarded as an input/output device and a communications connection). The one or more communication connections 820 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 800 may also include location circuitry 824. In various embodiments, the location circuitry 824 may include circuitry including global positioning system (GPS) circuitry and/or geolocation circuitry. The location circuitry 824 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 824, including GPS circuitry and/or geolocation circuitry, is frequently incorporated in smartphones and many other tablets or other portable devices. In various embodiments, computing system 800 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. A system comprising:
a plurality of perception sensors coupled to a vehicle;
one or more processors; and
logic encoded in one or more non-transitory computer-readable storage media for execution by the one or more processors and when executed operable to cause the one or more processors to perform operations comprising:
capturing data on an external environment using at least one perception sensor of the plurality of perception sensors, wherein the data on the external environment comprises data on a ground surface on a path of the vehicle;
detecting a hazardous condition associated with the path of the vehicle based on the data that is captured;
identifying a type of hazardous condition;
determining one or more attributes of the vehicle based on the type of hazardous condition; and
transmitting one or more passage alerts to one or more target recipients based on the hazardous condition and the one or more attributes of the vehicle.

2. The system of claim 1, wherein the at least one perception sensor of the plurality of perception sensors comprises at least one of a camera, a radar detector, a light detection and ranging (Lidar) camera, or an ultrasonic camera.

3. The system of claim 1, wherein the hazardous condition is associated with water, wherein the logic when executed is further operable to cause the one or more processors to perform operations comprising:
detecting water on the path of the vehicle based on the data that is captured;
estimating a depth of the water; and
transmitting one or more passage alerts to one or more target recipients based on an estimated depth of the water.

4. The system of claim 1, wherein the logic when executed is further operable to cause the one or more processors to perform operations comprising fetching crowdsourced data on the hazardous condition.

5. The system of claim 1, wherein the logic when executed is further operable to cause the one or more processors to perform operations comprising modifying the one or more passage alerts for each target recipient of the one or more target recipients based on one or more alert policies.

6. The system of claim 1, wherein at least one passage alert of the one or more passage alerts is transmitted to a driver of the vehicle, and wherein the at least one service alert indicates if passage through the hazardous condition is safe.

7. The system of claim 1, wherein at least one service alert of the one or more service alerts is transmitted to at least one third party entity, and wherein the least one third party entity alerts other drivers of any hazardous conditions.

8. A non-transitory computer-readable storage medium with program instructions stored thereon, the program instructions when executed by one or more processors are operable to cause the one or more processors to perform operations comprising:
capturing data on an external environment using at least one perception sensor of a plurality of perception sensors, wherein the data on the external environment comprises data on a ground surface on a path of the vehicle;
detecting a hazardous condition associated with the path of the vehicle based on the data that is captured;
identifying a type of hazardous condition;
determining one or more attributes of the vehicle based on the type of hazardous condition; and
transmitting one or more passage alerts to one or more target recipients based on the hazardous condition and the one or more attributes of the vehicle.

9. The computer-readable storage medium of claim 8, wherein the at least one perception sensor of the plurality of perception sensors comprises at least one of a camera, a radar detector, a light detection and ranging (Lidar) camera, or an ultrasonic camera.

10. The computer-readable storage medium of claim 8, wherein the hazardous condition is associated with water, wherein the instructions when executed are further operable to cause the one or more processors to perform operations comprising:
detecting water on the path of the vehicle based on the data that is captured;
estimating a depth of the water; and
transmitting one or more passage alerts to one or more target recipients based on an estimated depth of the water.

11. The computer-readable storage medium of claim 8, wherein the instructions when executed are further operable to cause the one or more processors to perform operations comprising fetching crowdsourced data on the hazardous condition.

12. The computer-readable storage medium of claim 8, wherein the instructions when executed are further operable to cause the one or more processors to perform operations comprising modifying the one or more passage alerts for each target recipient of the one or more target recipients based on one or more alert policies.

13. The computer-readable storage medium of claim 8, wherein at least one passage alert of the one or more passage alerts is transmitted to a driver of the vehicle, and wherein the at least one service alert indicates if passage through the hazardous condition is safe.

14. The computer-readable storage medium of claim 8, wherein at least one service alert of the one or more service alerts is transmitted to at least one third party entity, and wherein the least one third party entity alerts other drivers of any hazardous conditions.

15. A computer-implemented method for providing vehicle demos and conversations with product experts, the method comprising:
capturing data on an external environment using at least one perception sensor of a plurality of perception sensors, wherein the data on the external environment comprises data on a ground surface on a path of the vehicle;
detecting a hazardous condition associated with the path of the vehicle based on the data that is captured;
identifying a type of hazardous condition;
determining one or more attributes of the vehicle based on the type of hazardous condition; and
transmitting one or more passage alerts to one or more target recipients based on the hazardous condition and the one or more attributes of the vehicle.

16. The method of claim 15, wherein the at least one perception sensor of the plurality of perception sensors comprises at least one of a camera, a radar detector, a light detection and ranging (Lidar) camera, or an ultrasonic camera.

17. The method of claim 15, wherein the hazardous condition is associated with water, and wherein the method further comprises:
detecting water on the path of the vehicle based on the data that is captured;
estimating a depth of the water; and
transmitting one or more passage alerts to one or more target recipients based on an estimated depth of the water.

18. The method of claim 15, further comprising fetching crowdsourced data on the hazardous condition.

19. The method of claim 15, further comprising modifying the one or more passage alerts for each target recipient of the one or more target recipients based on one or more alert policies.

20. The method of claim 15, wherein at least one passage alert of the one or more passage alerts is transmitted to a driver of the vehicle, and wherein the at least one service alert indicates if passage through the hazardous condition is safe.
